(19) United States
(12) Patent Application Publication
(10) Pub. No.: US 2006/0049228 A1
(43) Pub. Date: Mar. 9, 2006

(54) Fastener driving structure for a dual-use fastener magazine

(76) Inventor: Roger Shen, Taichung City (TW)

Correspondence Address: CHARLES E. BAXLEY, ESQ., 90 JOHN STREET, THIRD FLOOR, NEW YORK, NY, 10038, US

(21) Appl. No.: 10/924,083

(22) Filed: Aug. 23, 2004

(51) Int. Cl. B25C 5/02

(52) U.S. Cl. 227/120; 227/109

(57) ABSTRACT

A fastener driving structure for a dual-use fastener magazine comprises: an auxiliary plate assembly is installed in a fastener magazine for cooperating with a fastener driving plate assembly and includes an auxiliary plate, a spring and a guiding member. The spring is slidably received in the auxiliary cavity of the fastener magazine, the auxiliary plate is slidably installed in the auxiliary cavity of the fastener magazine via the guiding member which is pressed on the spring. The fastener driving structure of the present invention is able to feed the long fasteners and the short fasteners stably and smoothly.

### BACKGROUND OF THE INVENTION

1. Field of the Invention

The present invention relates to a dual-use fastener magazine, and more particularly to a fastener driving structure for a dual-use fastener magazine, including a fastener driving plate assembly and an auxiliary plate assembly that cooperate with each other to push the long staple and the short staple stably.

2. Description of the Prior Arts

Conventional staple magazine is usually provided with a fastener driving plate, for example, a conventional fastener magazine 10 (as shown in FIGS. 1 and 2) is interiorly defined with a drive channel 11 for accommodation of the long staples 15 and the short staples 16. To an end of the drive channel 11 are fixed a restoring spring 12 and fastener driving plate 13, respectively. The fastener driving plate 13 is pushed by the restoring spring 12 to abut against the bottom of the fastener stripe 14. This conventional fastener magazine has been used on the stapler for a long time and has become the mainstream in the current market. However, it still has some practical defects that need to be solved as follows:

First, during the course of loading the long fasteners 15 into the drive channel 11, the fastener driving plate 13 and the restoring spring 12 are located off-center due to the fastener driving plate 13 is also designed to cooperate with the short fasteners 16. In this case, the long fasteners 15 are pushed by the fastener driving plate 13 and the restoring spring 12 in an off-center position, thus, the long fasteners 15 cannot be pushed steadily, and the long fasteners 15 cannot be fed stably.

Second, during the course of loading the short fasteners 16 into the drive channel 11, since the fastener driving plate 13 and the restoring spring 12 are located in an off-center position, the short fasteners 16 can be pushed stably. However, a gap 17 will be left in the magazine since the short fasteners 16 are located at a side of the drive channel, the short fasteners 16 are likely to be pushed into the gap 17 under the influence of gravity and destroyed therein. Thus, the fastener magazine is easy to be damaged.

The present invention has arisen to mitigate and/or obviate the afore-described disadvantages of the conventional fastener magazine.

### SUMMARY OF THE INVENTION

The primary object of the present invention is to provide a fastener driving structure for a dual-use fastener magazine, wherein an auxiliary plate assembly is used cooperate with a fastener driving plate assembly, when the short fasteners are loaded in the magazine, the auxiliary plate will fill in the gap left in the magazine, so that the short fasteners can be smoothly and stably pushed out of the magazine without being destroyed in the gap.

The secondary object of the present invention is to provide a fastener driving structure for a dual-use fastener magazine, wherein an auxiliary plate assembly is used cooperate with a fastener driving plate assembly, when the long fasteners are loaded in the magazine, the fastener driving plate assembly will cooperate with the auxiliary plate assembly to push both sides of the bottom of the long fasteners. Thus, the long fasteners not only can be fed stably but also can be pushed out of the magazine smoothly.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 shows long fasteners are loaded in the conventional fastener magazine;

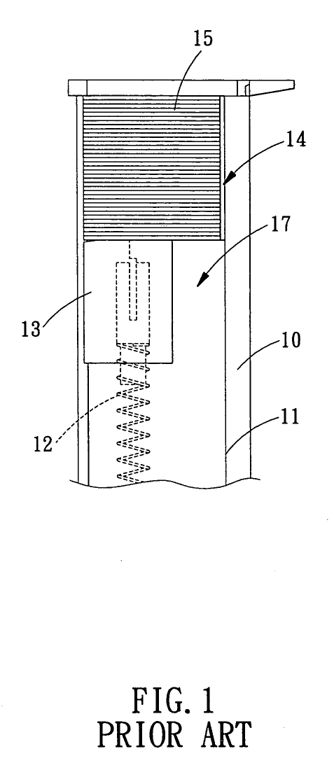

FIG. 2 shows short fasteners are loaded in the conventional fastener magazine;

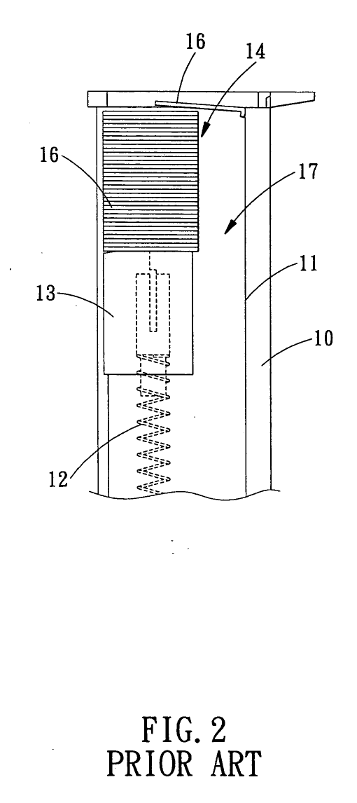

FIG. 3 is a partial exploded view of a fastener magazine in accordance with the present invention;

FIG. 4 is a cross sectional view of a fastener magazine in accordance with the present invention;

FIG. 5 shows long fasteners are loaded in the fastener magazine in accordance with the present invention;

FIG. 6 shows short fasteners are loaded in the fastener magazine in accordance with the present invention.

### DETAILED DESCRIPTION OF THE PREFERRED EMBODIMENT

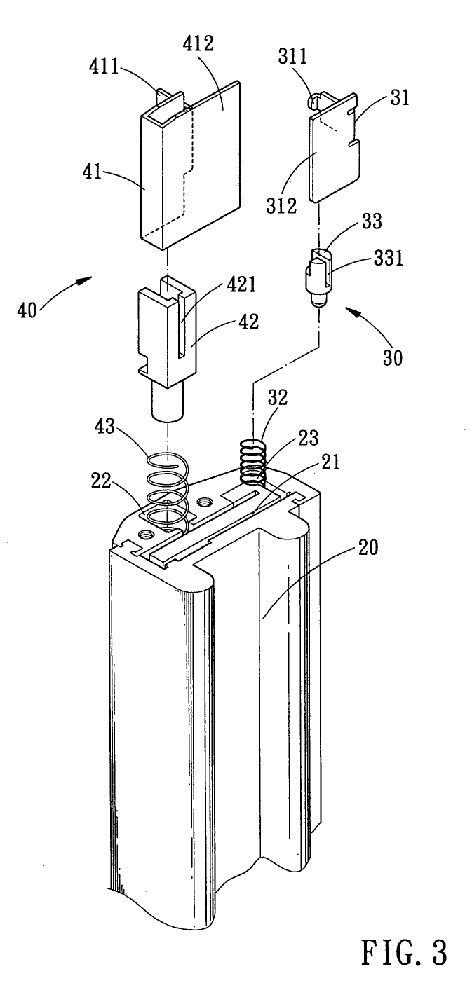

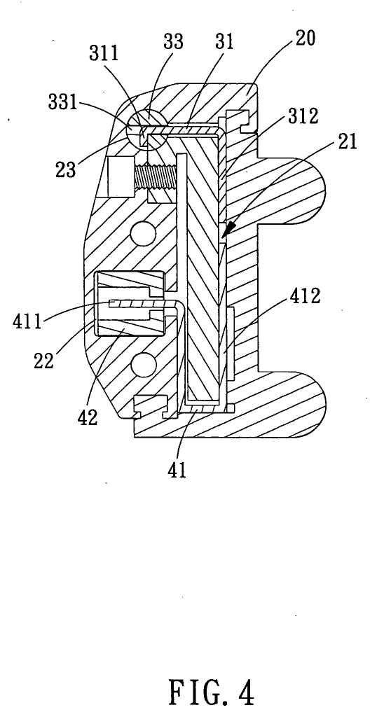

Referring to FIGS. 3-5, a fastener driving structure for a dual-use fastener magazine in accordance with a preferred embodiment of the present invention is shown and generally includes:

A magazine 20 comprises plural plates, in which is formed a drive channel 21 for the accommodation of long fasteners 50 and short fasteners 51. A spring cavity 22 and a circular auxiliary cavity 23 are vertically formed adjacent to the drive channel 21.

An auxiliary plate assembly 30 includes a T-shaped auxiliary plate 31, a spring 32 and a column-shaped guiding member 33. On top surface of the guiding member 33 is formed a L-shaped groove 331, at a side of the auxiliary plate 31 is provided a L-shaped projecting plate 311, at another side of the auxiliary plate 31 is provided an abutting portion 312 which corresponds to the drive channel 21 of the fastener magazine 20. The L-shaped projecting plate 311 of the auxiliary plate 31 is inserted in the L-shaped groove 331 of the column-shaped guiding member 33. The spring 32 is slidably received in the auxiliary cavity 23 of the fastener magazine 20. The auxiliary plate 31 is also slidably installed in the auxiliary cavity 23 of the fastener magazine 20 via the column-shaped guiding member 33 which is pressed on the spring 32.

A fastener driving plate assembly 40 comprises a fastener driving plate 41, a guiding block 42 and a spring 43. The fastener driving plate 41 is provided at a side with a projecting plate 411 that is used to insert in the slot 421 of the guiding block 42. At another side of the fastener driving plate 41 is formed a projecting portion 412 corresponding to the drive channel 21 of the fastener magazine 20. The projection portion 412 is used to cooperate with the abutting portion 312 of the auxiliary plate assembly 30. The spring 43 is slidably received in the spring cavity 22 of the fastener magazine 20, the fastener driving plate 41 uses the guiding block 42 to press on the spring 43.

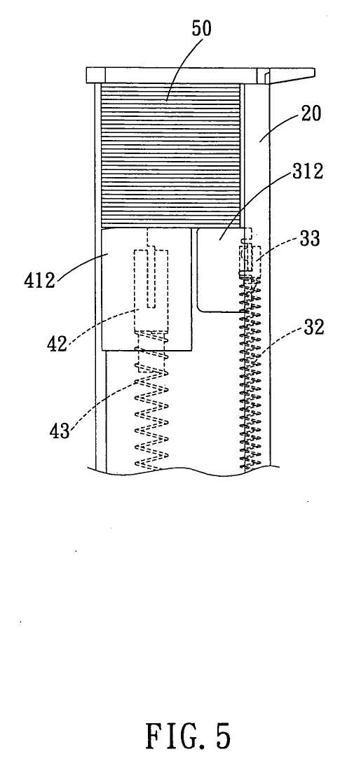

Referring particularly to FIG. 5, when the fastener magazine of the present invention is loaded with the long fasteners 50, the projecting portion 412 of the fastener driving plate assembly 40 will cooperate with the abutting portion 312 of the auxiliary plate assembly 30 to abut both sides of the bottom of the long fasteners 50. Thus, the long fasteners 50 not only can be fed stably but also can be pushed out of the magazine smoothly.

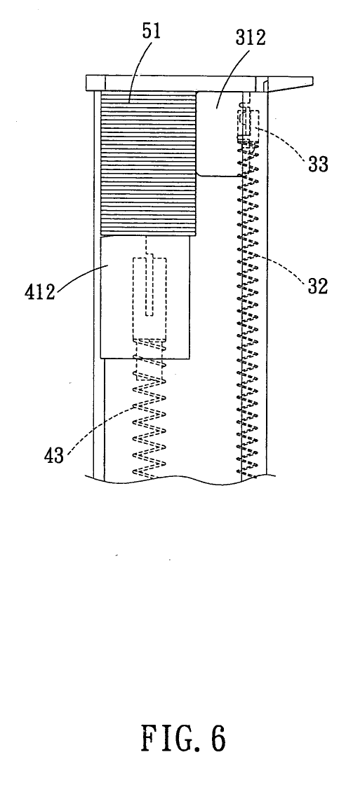

Referring to FIG. 6, when the fastener magazine of the present invention is loaded with the short fasteners 51, the projecting portion 412 of the fastener driving plate assembly 40 will push the short fasteners 51, while the abutting portion 312 of the auxiliary plate assembly 30 will be pushed by the spring 32 to fill in the gap left by the short fasteners 51 (the gap 17 of the conventional fastener magazine as mentioned above). It prevents the short fasteners 51 from being falling into the gap 17 of the conventional fastener magazine, thus the short fasteners 51 can be smoothly pushed out of the magazine under the support of the abutting portion 312 without being destroyed in the gap. Furthermore, the service life of the magazine of the present invention is accordingly prolonged and the operation is relatively easy.

While we have shown and described various embodiments in accordance with the present invention, it should be clear to those skilled in the art that further embodiments may be made without departing from the scope of the present invention.

1. A fastener driving structure for a dual-use fastener magazine comprising:
a magazine interiorly formed with a drive channel, a fastener driving plate assembly disposed in the drive channel and employed to push fasteners, a spring cavity for reception of a first spring, a circular auxiliary cavity and the drive channel formed sequentially on the magazine;
an auxiliary plate assembly including an auxiliary plate, a second spring and a guiding member, wherein a L-shaped groove is formed on top surface of the cylindrical guiding member, at a side of the auxiliary plate is provided a L-shaped projecting plate, at another side of the auxiliary plate is provided an abutting portion corresponding to the drive channel of the fastener magazine, the abutting portion is used to cooperate with the fastener driving plate assembly, the L-shaped projecting plate of the auxiliary plate is inserted in the L-shaped groove of the guiding member, the second spring is slidably received in the auxiliary cavity of the fastener magazine, the auxiliary plate is slidably installed in the auxiliary cavity of the fastener magazine via the guiding member which is pressed on the spring, and the guiding member is slidably installed in the auxiliary cavity of the fastener magazine.

2. (canceled)
